(19) United States
(12) Patent Application Publication
(10) Pub. No.: US 2024/0058734 A1
(43) Pub. Date: Feb. 22, 2024

(54) FILTER ASSEMBLIES WITH COMBINED AXIAL AND RADIAL SEALING

(71) Applicant: CUMMINS FILTRATION INC., Nashville, TN (US)

(72) Inventors: Sunny Nabhiraj Masutage, Miraj (IN); Wassem Abdalla, Fishers (IN)

(73) Assignee: CUMMINS FILTRATION INC., Nashville, TN (US)

(21) Appl. No.: 18/271,295

(22) PCT Filed: Dec. 6, 2021
(86) PCT No.: PCT/US2021/062035

§ 371 Date: Jul. 7, 2023

Related U.S. Application Data
(60) Provisional application No. 63/135,105, filed on Jan. 8, 2021.

(51) Int. Cl. B01D 46/24; B01D 29/15

(52) U.S. Cl. CPC B01D 46/2414; B01D 29/15; B01D 2271/022; B01D 2271/027; B01D 2201/304; B01D 2201/295; B01D 2201/4076; B01D 2201/4053

(57) ABSTRACT

A filter cartridge comprises a filter housing having a filter element disposed therewithin that comprises a filter media, and an end cap coupled to a top end of the filter media. The top end is positionable proximate to a filter head. A filter element outlet conduit extends from an inner rim of the end cap towards the filter head and is extendable into a filter head outlet. An end cap ledge extends radially outwards from an outer periphery of the end cap. A first sealing member is disposed at least partially on the end cap ledge and forms an axial seal with the filter head, and a second sealing member is disposed around the filter element outlet conduit on a radially outward surface thereof, and forms a radial seal with a radially inward surface of the filter head outlet conduit when the filter head is coupled to the filter cartridge.

### CROSS-REFERENCE TO RELATED APPLICATIONS

The present application is a national phase of PCT Application No. PCT/US2021/062035, filed Dec. 6, 2021 which claims priority to and benefit of U.S. Provisional Application No. 63/135,105, filed Jan. 8, 2021. The contents of these applications are incorporated herein by reference.

### TECHNICAL FIELD

The present disclosure relates generally to filters for use with internal combustion engine systems.

### BACKGROUND

Internal combustion engines generally use various fluids during operation. For example, fuel (e.g., diesel, gasoline, natural gas, etc.) is used to run the engine. Air may be mixed with the fuel to produce an air-fuel mixture, which is then used by the engine to run under stoichiometric or lean conditions. Furthermore, one or more lubricants may be provided to the engine to lubricate various parts of the engine (e.g., piston cylinder, crank shaft, bearings, gears, valves, cams, etc.). These fluids may become contaminated with particulate matter (e.g., carbon, dust, metal particles, etc.) which may damage the various parts of the engine if not removed from the fluid. Some filter assemblies comprise a filter element positioned within a filter housing, such as a shell housing. The shell housing is generally coupled to a filter head which may define one or more conduits to receive filtered fluid from the filter element. Leakage of fluid can occur between the filter head and the filter element causing contamination of the clean fluid on the clean side of the filter element with dirty fluid from the dirty side of the filter media which is undesirable.

### SUMMARY

Embodiments described herein relate generally to systems and methods for forming an axial seal and a radial seal between a filter element and a filter head, and in particular, a filter element including an end cap that is structured to mount a first sealing member and a second sealing member at separate locations such that the first sealing member forms an axial seal between at least the filter head and the end cap, and the second sealing member forms a radial seal between the end cap and the filter head.

In a set of embodiments, a filter cartridge comprises a filter housing defining an internal volume. A filter element is disposed within the internal volume and comprises: a filter media, and an end cap coupled to a top end of the filter media, the top end positionable proximate to a filter head. A filter element outlet conduit extends from an inner rim of the end cap towards the filter head and is extendable into a filter head outlet conduit of the filter head, and an end cap ledge extends radially outwards from an outer periphery of the end cap. A first sealing member is disposed around the outer periphery of the end cap at least partially on the end cap ledge. A second sealing member is disposed around the filter element outlet conduit on a radially outward surface of the filter element outlet conduit. The first sealing member forms an axial seal between the end cap and filter head, and the second sealing member forms a radial seal between the radially outward surface of the filter element outlet conduit and a radially inward surface of the filter head outlet conduit when the filter cartridge is coupled to the filter head.

In another set of embodiments, a filter cartridge comprises a filter housing defining an internal volume. A filter element is disposed within the internal volume. The filter element comprises: a filter media, and an end cap coupled to a top end of the filter media, the top end positionable proximate to a filter head. The end cap defines a central opening around a longitudinal axis of the filter cartridge, the central opening structured to receive a filter head outlet conduit of the filter head. A first sealing member is disposed proximate to an outer periphery of the end cap and coupled to the end cap, and a second sealing member is disposed around an inner periphery of the central opening. The first sealing member forms an axial seal between the end cap and filter head, and the second sealing member forms a radial seal between the inner periphery of the central opening and the filter head outlet conduit of the filter head when the filter cartridge is coupled to the filter head.

In still another set of embodiments, a filter cartridge comprises a filter housing defining an internal volume. A filter element is disposed within the internal volume. The filter element comprises a filter media comprising a first end and a second end opposite the first end, and an end cap coupled to the first end of the filter media, a filter element outlet conduit extending from an inner rim of the end cap away from the second end. A first sealing member is disposed proximate to a radially outer periphery of the end cap and coupled to the end cap. The first sealing member comprises a first sealing member sealing portion disposed on a surface of the end cap that is axially opposite the filter media, and a set of first sealing member arms extending axially toward the second end from a radially inner edge of the first sealing member sealing portion and disposed radially inwards of an outer peripheral edge of the end cap. A second sealing member is disposed around the filter element outlet conduit on a radially outward surface of the filter element outlet conduit.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a side cross-sectional view of a filter cartridge, according to an embodiment.

FIG. 2 is an exploded view of a portion of the filter cartridge of FIG. 1.

FIG. 3 is a top perspective view of a top end cap included in the filter cartridge of FIG. 1.

FIG. 4 is a bottom perspective view of the top end cap of FIG. 3.

FIG. 5 is a side cross-sectional view of a portion of a filter cartridge including a top end cap having a conical filter element outlet conduit, according to another embodiment.

FIG. 6A is a top perspective view of top end cap included in the filter cartridge of FIG. 5.

FIG. 6B is a side cross-sectional view of the top end cap of FIG. 6A taken along the line A-A in FIG. 6A.

FIG. 7 is a plot illustrating the amount of force vs. displacement distance observed in installing a filter element including a top end cap having a cylindrical filter element outlet conduit and a filter element including a top end cap having a conical filter element outlet conduit.

FIG. 8 is a side cross-section view of a portion of a filter cartridge including a top end cap having a divergent filter element outlet conduit, according to another embodiment.

FIG. 9 is a top perspective view of the top end cap included in the filter cartridge of FIG. 8.

FIG. 10 is a side cross-sectional view of the top end cap of FIG. 9 taken along the line B-B in FIG. 9.

FIG. 11 is a cross-sectional perspective view of a filter cartridge, according to still another embodiment.

FIG. 12 is an exploded view of the filter cartridge of FIG. 11

FIG. 13 is a side cross-section view of a portion of the filter cartridge of FIG. 11.

FIG. 14 is an enlarged view of a portion of the filter cartridge of FIG. 13 indicated by the arrow A in FIG. 13.

FIG. 15 is a top view of a top end cap included in the filter cartridge of FIG. 11.

FIG. 16 is a bottom perspective view of the top end cap of FIG. 15.

FIG. 17 is a cross-sectional view of a top end cap, according to an embodiment.

FIG. 18 is a cross-sectional view of a top end cap, according to another embodiment.

FIG. 19 is a cross-sectional view of a top end cap, according to still another embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to systems and methods for forming an axial seal and a radial seal between a filter element and a filter head, and in particular, a filter element including an end cap that is structured to mount a first sealing member and a second sealing member at separate locations such that the first sealing member forms an axial seal between at least the filter head and the end cap, and the second sealing member forms a radial seal between the end cap and the filter head.

Various filter assemblies comprise a filter element positioned within a filter housing, such as a shell housing. The shell housing is removably coupled to a filter head which may define one or more conduits to receive filtered fluid from the filter element. Leakage of fluid can occur between the filter head and the filter element, causing contamination of the clean fluid on the clean side of the filter element with dirty fluid from the dirty side of the filter media which is undesirable.

To prevent leakage, some filter assemblies include two sealing members, each of which is configured to form an axial seal between an end cap of the filter element and a filter head to which the filter cartridge is coupled. The two axial seal design may be sensitive to dimensional variations and very tight tolerances may be needed to achieve desired sealing from each of the seals. The inner seal member of such filter cartridge may rely on the coupling between the filter head and the filter cartridge as well as the geometry of the outer seal member for achieving sufficient compression for an adequate seal. A cantilever effect and plastic creep can impact the inner seal compression and thereby the sealing efficiency. Moreover, in case of lubricant filter assemblies, the inner and outer seals may be exposed to high pressures and temperatures that can also cause failure in such designs.

In contrast, embodiments of the filter cartridge described herein that include an axial seal and a radial seal to provide fluid sealing may provide one or more benefits including, for example: (1) providing more efficient and resilient sealing relative to conventional filter cartridges including two axial seals; (2) allowing easy integration into existing filter cartridge designs; (3) reducing the installation force or torque required for installation; (4) reducing tendency of leakage occurring due to vibrations because of the use of only one axial seal; (5) inhibiting compression effect and corresponding loss in compression for inner radial seal at higher operating temperature, thereby reducing creep; (6) providing reduced resistance to fluid flow, especially at higher flow rates; (7) integrating sealing in compact and cost effective design; (8) facilitating servicing by providing locking of the seal between the end plate and a filter housing; (9) allowing installation using a constant force and inhibiting any jerks or sudden impacts during installation via a conical filter element outlet conduit of the end cap; (10) reducing pressure loss by providing a divergent filter element outlet conduit in the end cap; and (11) reducing weight of the filter element and material usage in manufacturing the filter element.

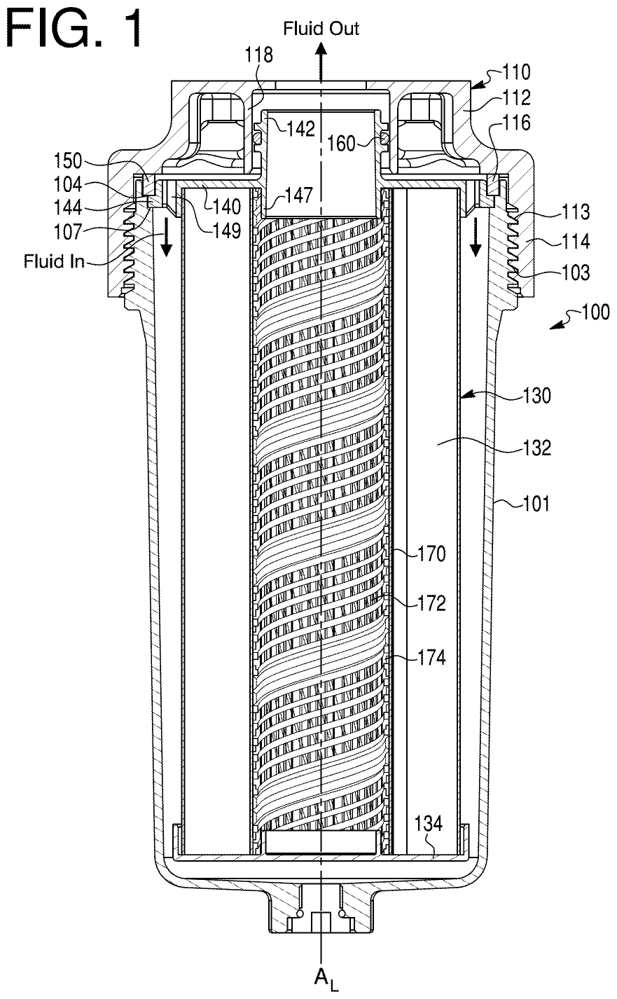

FIG. 1 is a side cross-section of a filter cartridge 100 according to an embodiment. The filter cartridge 100 may be used to filter a liquid (e.g., lubricant, fuel, etc.), a gas (e.g., air), air/fuel mixture, or another fluid provided to an engine. The filter cartridge 100 comprises a filter housing 101 configured to be coupled to a filter head 110, a filter element 130 including a top end cap 140, a first sealing member 150, and a second sealing member 160, as described in detail herein.

The filter housing 101 defines an internal volume within which the filter element 130 is positioned. The filter housing 101 may be formed from a strong and rigid material, for example plastics (e.g., polypropylene, high density polyethylene, polyvinyl chloride, etc.), metals (e.g., aluminum, stainless steel, etc.), polymers (e.g., reinforced rubber, silicone) or any other suitable material. In particular embodiments, the filter housing 101 may comprise a cylindrical housing having generally a circular cross-section. In particular embodiments, the filter housing 101 may comprise a shell housing.

A top end of the filter housing 101 may define coupling features 103 configured to couple the filter housing 101 to the filter head 110. In some embodiments, the coupling features 103 may include a set of threads formed on a radially outer surface of the housing 101, which are configured to mate with a corresponding set of mating threads 113 defined on an inner surface of the filter head 110. For example, the filter head 110 may include a filter head main portion 112 and a flange portion 114 extending axially from an outer peripheral edge of the filter head main portion 112 towards the filter housing 101. The set of mating threads 113 may be defined on a radially inner surface of the flange portion 114. In other words, the filter cartridge 100 may be a spin-on filter cartridge configured to be threaded onto the filter head 110. The filter head 110 may include, for example, a receiving structure of a system (e.g., an engine or a vehicle) structured to allow mounting of the filter cartridge 100 thereto. The filter head 110 is configured to communicate unfiltered fluid (e.g., lubricant, air, fuel or air/fuel mixture) to the filter cartridge 100 and receive filtered fluid therefrom. For example, the filter head 110 also includes a filter head outlet conduit 118 disposed radially inwards of the flange portion 114 and extending axially from the filter head main portion 112 towards the filter cartridge 100. The filter head outlet conduit 118 is structured to receive clean fluid that has been filtered by the filter cartridge 100 and communicate the clean fluid out of the filter head.

The filter element 130 is positioned along a longitudinal axis A_{L} of the filter cartridge 100 within an internal volume defined by the filter housing 101. The filter element 130 comprises a filter media 132. The filter media 132 includes a porous material having a predetermined pore size and is configured to filter particulate matter from the fluid flowing therethrough. The filter media 132 or any other filter media described herein may include pleated media, tetrahedral media, fluted filter media, corrugated filter media or variations thereof.

As shown in FIG. 1, the filter media 132 is a radial flow filter media, i.e., structured to filter the fluid as it flows radially through the filter media 132. The filter media 132 defines a central channel within which a center tube 170 is disposed. In particular embodiments, the center tube 170 may be included in the filter element 130, for example, the filter media 132 may be wound around or be otherwise coupled to the center tube 170. The center tube 170 may be formed from any suitable material, for example, polymers, plastics, etc. The center tube 170 defines a center tube channel 172 in fluid communication with the filter head outlet conduit 118 of the filter head 110 via the top end cap 140, as described in further detail herein. Dirty fluid may enter the filter housing 101 around the filter media 132 and flow radially through the filter media 132 while being filtered in the process. The center tube 170 defines a plurality of center tube openings 174. The filtered clean fluid (e.g., filtered air, fuel, air/fuel mixture, lubricant, etc.) flows through the plurality of center tube openings 174 into the center tube channel 172 after being filtered by the filter media 132, and therefrom to the filter head outlet conduit 118 through the top end cap 140.

The top end cap 140 is coupled to a top end of the filter media 132 that is located proximate to the filter head 110 when the filter cartridge 100 is coupled to the filter head 110. The filter element 130 may also include a bottom end cap 134 coupled to a bottom end of the filter media 132 opposite the top end. The top end cap 140 and the bottom end cap 134 may be formed from any suitable material, for example, plastics, metals, rubber, reinforced rubber, polymers, etc. The top end cap 140 and, in some embodiments, the bottom end cap 134 may have a cross-section generally corresponding to an inner cross-section of the filter housing 101. In other embodiments, the cross-section of at least the bottom end cap 134 may be smaller than the cross-section of the filter housing 101. The bottom end cap 134 may protect the bottom end of the filter media 132 from damage as the filter element 130 is inserted into the filter housing 101 and/or maintain a shape (e.g., a cylindrical shape) of the filter media 132, so as to facilitate insertion of the filter element 130 into the filter housing 101 In particular embodiments, the top end cap 140 and the bottom end cap 134 may be fixedly coupled to the top end and bottom end of the filter media 132, respectively via an adhesive or thermally bonded thereto.

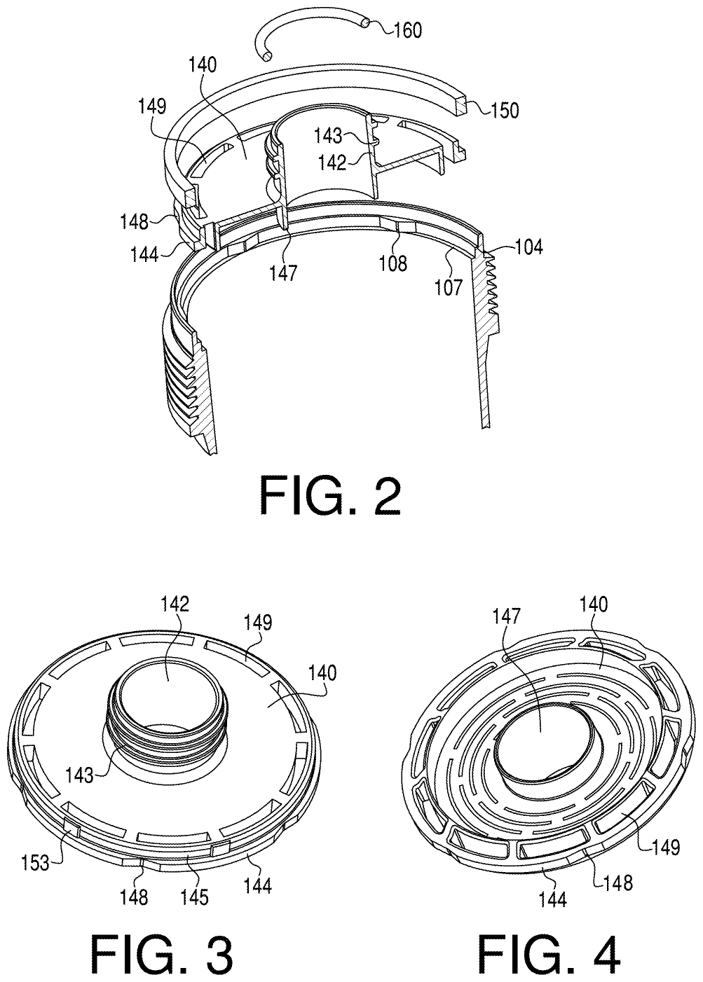

Referring also now to FIGS. 2-4, the top end cap 140 is structured to support the first sealing member 150 that forms an axial seal with the filter head 110, and the second sealing member 160 that forms a radial seal with the filter head 110. Expanding further, the top end cap 140 includes a filter element outlet conduit 142 extending from an inner rim of the top end cap 140 towards the filter head 110 and extends into the filter head outlet conduit 118 of the filter head 110. In some embodiments, the filter element outlet conduit 142 comprises a cylindrical wall having a substantially uniform cross-section. For example, a cross-section of an upstream end of the filter element outlet conduit 142 that is located proximate to the filter media 132 and is configured to receive filtered fluid via the center tube channel 172 of the center tube is substantially equal to a cross-section of a downstream end of the filter element outlet conduit 142.

A groove 143 is formed on an outer periphery of the filter element outlet conduit 142 and the second sealing member 160 is disposed in the groove 143 such that the second sealing member 160 is disposed on a radially outward surface of the filter element outlet conduit 142. The second sealing member 160 may include an O-ring or any other suitable sealing member. The second sealing member 160 forms a radial seal between the radially outward surface of the filter element outlet conduit 142 and a radially inward surface of the filter head outlet conduit 118 of the filter head 110 when the filter element outlet conduit 142 is inserted into the filter head outlet conduit 118. In some embodiments, the filter element outlet conduit 142 may also include an upstream portion 147 that extends from the inner rim of the top end cap 140 into the center tube channel 172.

The first sealing member 150 may include a gasket having a square or rectangular cross-section. An end cap ledge 144 extends radially outwards from an outer periphery 145 of the top end cap 140, and the first sealing member 150 is disposed around the outer periphery 145 of the top end cap 140 at least partially on the end cap ledge 144. The first sealing member 150 forms an axial seal between the top end cap 140 and the filter head 110, for example, an axially lower surface 116 of the filter head main portion 112 and an axially upper surface of the end cap ledge 144. In some embodiments, a plurality of protrusions 153 may be formed on the outer periphery 145 of the top end cap 140 and structured to secure the first sealing member 150 to the outer periphery 145 of the top end cap 140, for example, via a friction fit or compression fit.

In some embodiments, the filter housing 101 further comprises a first housing ledge 104 defined on an inner surface of the filter housing 101 proximate to the end cap ledge 144, which extends radially inwards from an inner surface of the filter housing 101. At least a portion of the first sealing member 150 may be disposed on the first housing ledge 104 such that the first sealing member 150 forms an axial seal also between the filter housing 101 and the filter head 110. Thus, the outer periphery 145 of the top end cap 140, the end cap ledge 144, the first housing ledge 104, and an inner surface of the filter housing 101 form a groove for receiving the first sealing member 150.

In some embodiments, a plurality of detents 108 may be defined on inner surface of the filter housing 101, for example, below the first housing ledge 104. A plurality of indents 148 may be formed on an outer peripheral surface of the end cap ledge 144 at locations on the end cap ledge 144 corresponding to a location of the plurality of detents 108 such that each of the plurality of detents 108 is inserted into a corresponding indent 148 when the filter element 130 is disposed in the filter housing 101. The detents 108 and the indents 148 may serve as alignment features and may also prevent rotation of the filter element 130 relative to the filter housing 101.

In some embodiments, the filter housing 101 defines a second housing ledge 107 defined in the filter housing 101 below the first housing ledge 104, the second housing ledge 107 extending radially inward from an inner surface of the filter housing 101 below the first housing ledge 104. In some embodiments, each of the first housing ledge 104 and the second housing ledge 107 may be disposed circumferentially about the inner surface of the housing 101. The end cap ledge 144 may be disposed on the second housing ledge 107. Thus, the filter element 130 may be supported in the filter housing 101 by the end cap ledge 144 on the second housing ledge 107. As the filter housing 101 is threaded on to the filter head 110, the second housing ledge 107 pushes the top end cap 140 and thereby, the first sealing member 150 towards the filter head 110 to form an axial seal therebetween.

A plurality of openings 149 are defined through the top end cap 140 proximate to, and radially inwards of the outer periphery 145 of the top end cap 140. In some embodiments, each of the plurality of openings 149 may include a circumferential slot. Dirty fluid may be provided through the filter head 110 between the filter head outlet conduit 118 and the first sealing member 150. The dirty fluid enters through the plurality of openings 149 between the outer radial surface of the filter media 132 and the inner radial surface of the filter media 132, for being filtered by the filter media 132.

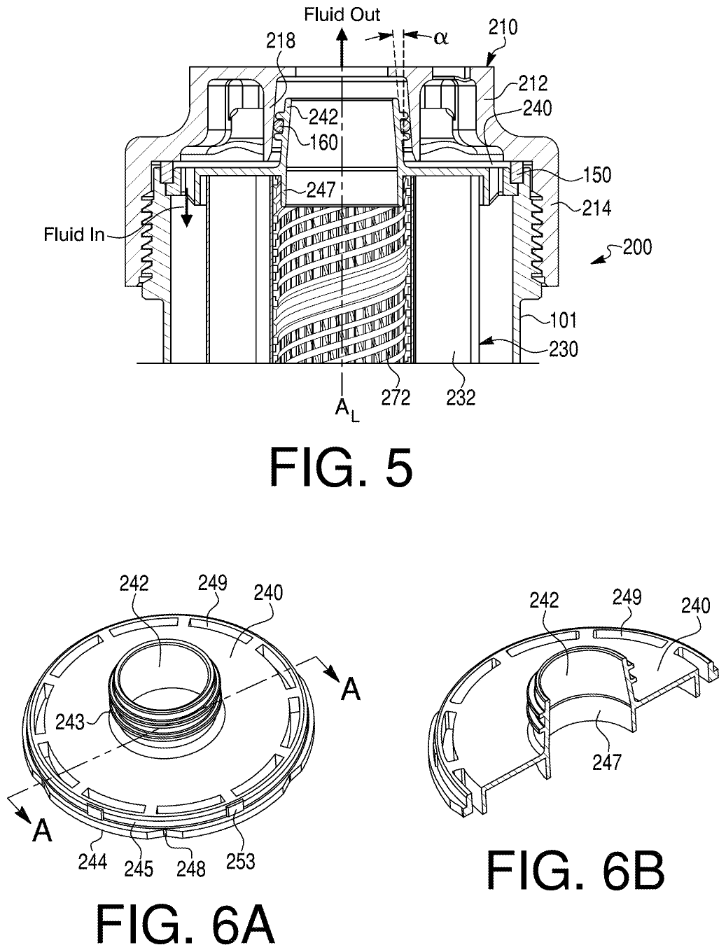

In some embodiments, a filter element outlet conduit included in a top end cap may define a convergent flow path. Referring to FIGS. 5-6B, various views of a filter cartridge 200 are shown, according to another embodiment. The filter cartridge 200 includes the filter housing 101 configured to be coupled to a filter head 210, a filter element 230, the first sealing member 150, and the second sealing member 160. The filter head 210 is substantially similar to the filter head 110 and includes a filter head main portion 212 and a flange portion 214 similar to the filter head main portion 112 and the flange portion 114. The filter head main portion 212 includes a filter head outlet conduit 218 extending from an axially inner surface of the filter head main portion 212 towards the filter cartridge 200. Different from the filter head outlet conduit 118, the filter head outlet conduit 218 has an upstream end that has a larger cross-section than a downstream end of the filter head outlet conduit 218, such that the filter head outlet conduit 218 has a constantly narrowing cross-section from its upstream end to its downstream end.

The filter element 230 includes a filter media 232, a top end cap 240, and may also include a bottom end cap (not shown), as described with respect to the filter element 130. The top end cap 240 is substantially similar to the top end cap 140 and includes a filter element outlet conduit 242 defining a groove 243 within which the second sealing member 160 is disposed such that the second sealing member 160 is disposed on a radially outward surface of the filter element outlet conduit 242. The filter element outlet conduit 242 may also include an upstream portion 247 that extends from the inner rim of the top end cap 240 into the central channel 272. An end cap ledge 244 extends radially from an outer periphery 245 of the top end cap 240, and the first sealing member 150 is disposed at least partially on the end cap ledge 244. The top end cap 240 also includes a plurality of protrusions 253 formed on the outer periphery 245 of the top end cap 240, a plurality of indents 248 formed on an outer peripheral surface of the end cap ledge 244, and a plurality of openings 249, as described with respect to the top end cap 140.

Different from the top end cap 140, the filter element outlet conduit 242 of the top end cap 240 includes a conical wall inclined radially inwards from an upstream end to a downstream end of the filter element outlet conduit 242 such that the upstream end of the filter element outlet conduit 242 has a larger cross-section than the downstream end of the filter element outlet conduit 242. In other words, the filter element outlet conduit 242 has a convergent cross-section from the upstream end to the downstream end thereof. In some embodiments, the wall of the filter element outlet conduit 242 may be inclined at an angle α in a range of 2 degrees to 8 degrees, inclusive with respect to an axis that is parallel to a longitudinal axis A_{L} of the filter cartridge 200.

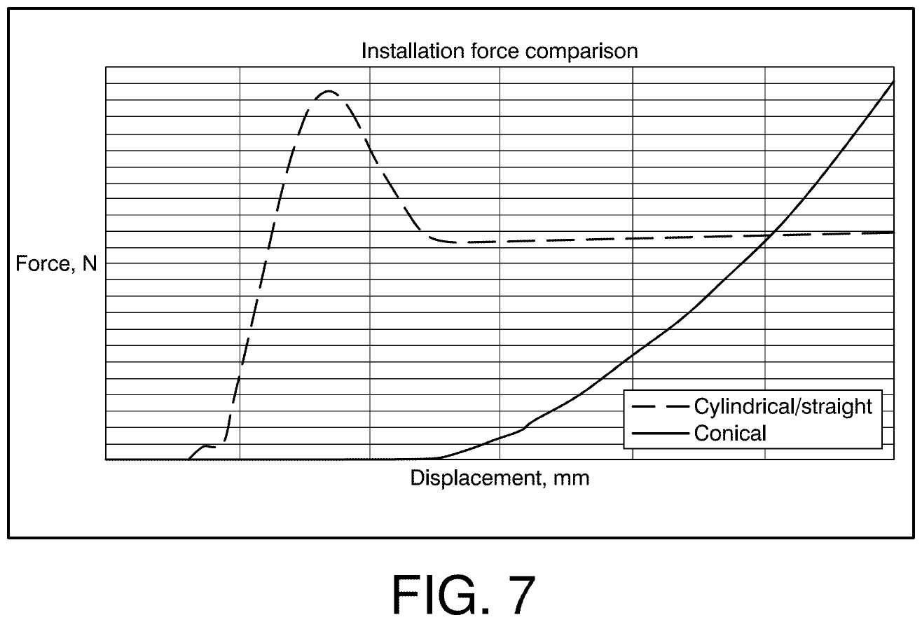

The conical filter element outlet conduit 242 that converges from its upstream to its downstream end is configured to mate with the conical filter head outlet conduit 218 of the filter head 210. The conical filter head outlet conduit 218 may inhibit mating of a top end plate having a non-conical filter element outlet conduit (e.g., a cylindrical filter element outlet conduit having a uniform cross-section along its length). This can help to prevent installation of improper filter cartridges to the filter head 210, which are incompatible or otherwise not intended to be used with the filter head 210. Moreover, the conical filter element outlet conduit 242 can be installed using lesser installation energy relative to a filter element outlet conduit including a non-conical cylindrical filter element outlet conduit. For example, as shown in FIG. 7, a large initial force is required to insert a filter cartridge having a cylindrical filter element outlet conduit that is non-conical into the filter head outlet conduit 218, which can damage the second sealing member 160 and can also lead to over-compression of the second sealing member 160. In contrast, significantly lesser force is required to insert the conical filter element outlet conduit 242 into the filter head outlet conduit 218 over the same travel distance. The required insertion force gradually increases as the filter element outlet conduit 242 is inserted further into the filter head outlet conduit 218, which serves as a feedback mechanism to a user installing the filter cartridge 200 onto the filter head 210 so as to inhibit the user from over compressing the first sealing member 150 and/or the second sealing member 160.

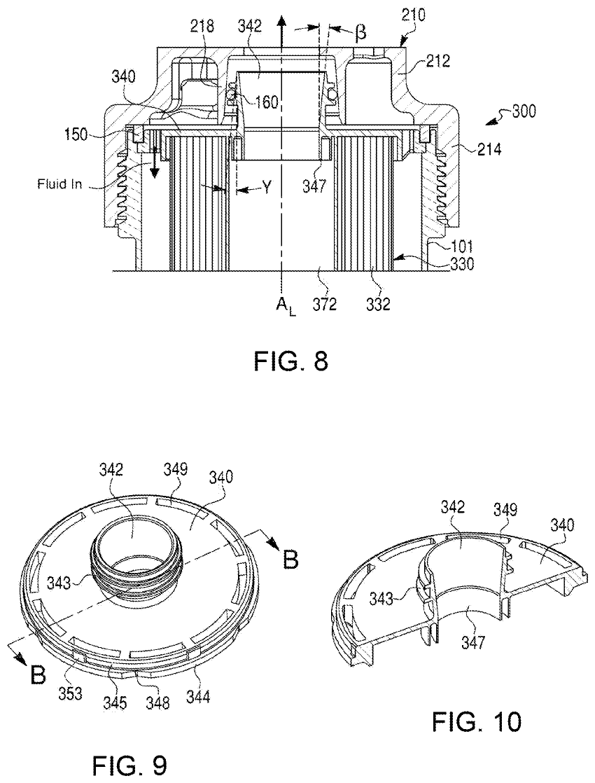

In some embodiments, a filter element outlet conduit included in a top end cap may define a divergent flow path. Referring to FIGS. 8-10, various view of a filter cartridge 300 are shown, according to still another embodiment. The filter cartridge 300 includes the filter housing 101 configured to be coupled to the filter head 210 including the filter head main portion 212, the flange portion 214 and the filter head outlet conduit 218, a filter element 330, the first sealing member 150, and the second sealing member 160.

The filter element 330 includes a filter media 332, a top end cap 340, and may also include a bottom end cap (not shown), as described with respect to the filter element 130. The top end cap 340 is substantially similar to the top end cap 240 and includes a filter element outlet conduit 342 defining a groove 343 within which the second sealing member 160 is disposed such that the second sealing member 160 is disposed on a radially outward surface of the filter element outlet conduit 342. However, as shown in FIG. 8, an outer radial surface of the surface on which the groove 343 is defined is inclined radially inwards at an angle γ, for example, in a range of 2 degrees to 8 degrees with respect to an axis that is parallel to a longitudinal axis A_{L} of the filter cartridge 300. Thus, the outer radial surface forms a conical or convergent sealing mechanism similar to the top end cap 240 of FIG. 5.

The filter element outlet conduit 342 may also include an upstream portion 347 that extends from the inner rim of the top end cap 340 into the central channel 372. An end cap ledge 344 extends radially from an outer periphery 345 of the top end cap 340. The first sealing member 150 is disposed at least partially on the end cap ledge 344. The top end cap 340 also includes a plurality of protrusions 353 formed on the outer periphery 345 of the top end cap 340, a plurality of indents 348 formed on an outer peripheral surface of the end cap ledge 344, and a plurality of openings 349, as described with respect to the top end cap 140.

Different from the top end cap 140 and 240, the filter element outlet conduit 342 of the top end cap 340 includes a conical wall inclined radially outwards from an upstream end to a downstream end of the filter element outlet conduit 342 such that the downstream end of the filter element outlet conduit 342 has a larger cross-section than the upstream end. In other words, the filter element outlet conduit 342 has a divergent cross-section from its upstream end to its downstream end. In some embodiments, the wall of the filter element outlet conduit 342 may be inclined at an angle β in a range of 2 degrees to 8 degrees, inclusive, with respect to an axis that is parallel to a longitudinal axis A_{L} of the filter cartridge 300. The divergent cross-section of the filter element outlet conduit 342 reduces velocity and increases pressure of the fluid as it flows through the filter element outlet conduit 342 which can facilitate recovery of pressure losses as the fluid flows through the filter cartridge 300.

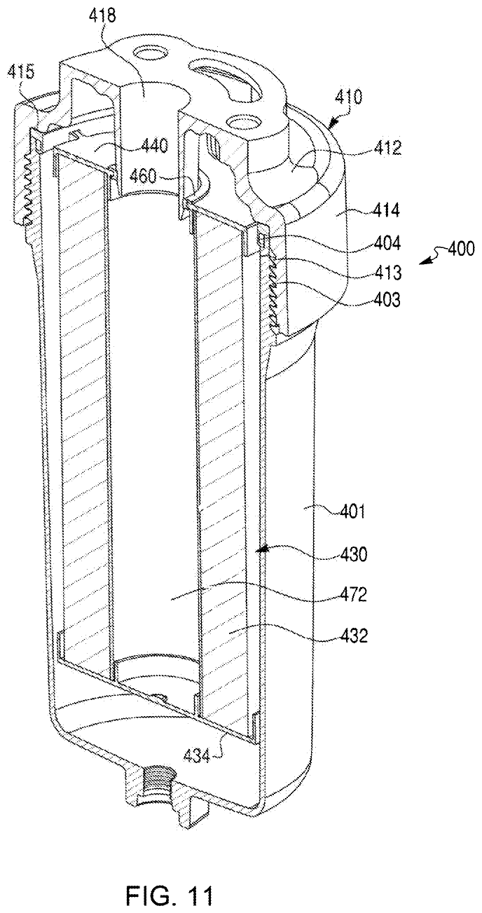

In some embodiments, a filter cartridge may include a first sealing member that is coupled to the top end plate. Referring to FIGS. 11-16, various views of a filter cartridge 400 are shown, according to an embodiment. The filter cartridge 400 comprises a filter housing 401 configured to be coupled to a filter head 410, a filter element 430 including a filter media 432 and a top end cap 440, a first sealing member 450, and a second sealing member 460.

The filter housing 401 defines an internal volume within which the filter element 430 is positioned. A top end of the filter housing 401 defines a set of threads 403 configured to couple the filter housing 401 to the filter head 410. The filter head 410 includes a filter head main portion 412 and a flange portion 414 extending axially from an outer peripheral edge of the filter head main portion 412 towards the filter housing 401. A set of mating threads 413 may be defined on a radially inner surface of the flange portion 414 and configured to mate with the set of threads 403 to couple the filter cartridge 400 to the filter head 410.

The filter head 410 also includes a filter head outlet conduit 418 disposed radially inwards of the flange portion 414 and extending axially from the filter head main portion 412 towards the filter cartridge 400. The filter head outlet conduit 418 is structured to receive clean fluid that has been filtered by the filter cartridge 400. The filter head outlet conduit 418 may have a length such that the filter head outlet conduit 418 extends into an axial central channel 472 defined within the filter media 432. While not shown, in some embodiments, a center tube may be disposed within the central channel 472. The filter media 432 is a radial flow filter media structured to filter the fluid as it flows radially through the filter media 432. Dirty fluid may enter the housing 401 around the filter media 432 and flow radially through the filter media 432 while being filtered in the process.

The top end cap 440 is coupled to a top end of the filter media 432 that is located proximate to the filter head 410 when the filter cartridge 400 is coupled to the filter head 410. The filter element 430 may also include a bottom end cap 434 coupled a bottom end of the filter media 432 opposite the top end. In particular embodiments, the top end cap 440 and the bottom end cap 434 may be fixedly coupled to the top end and bottom end of the filter media 432, respectively via an adhesive or thermally bonded thereto.

The top end cap 440 is structured to support the first sealing member 450 that forms an axial seal with the filter head 410, and the second sealing member 460 that forms a radial seal with the filter head 410. Different from the top end caps 140, 240, and 340, the top end cap 440 defines a central opening 442 around a longitudinal axis A_{L} of the filter cartridge 400. Clean fluid after being filtered through the filter media 432 enters the central opening 442 and exits the filter cartridge 400 through the central opening 442. The filter head outlet conduit 418 is inserted into the central channel 472 through the central opening 442.

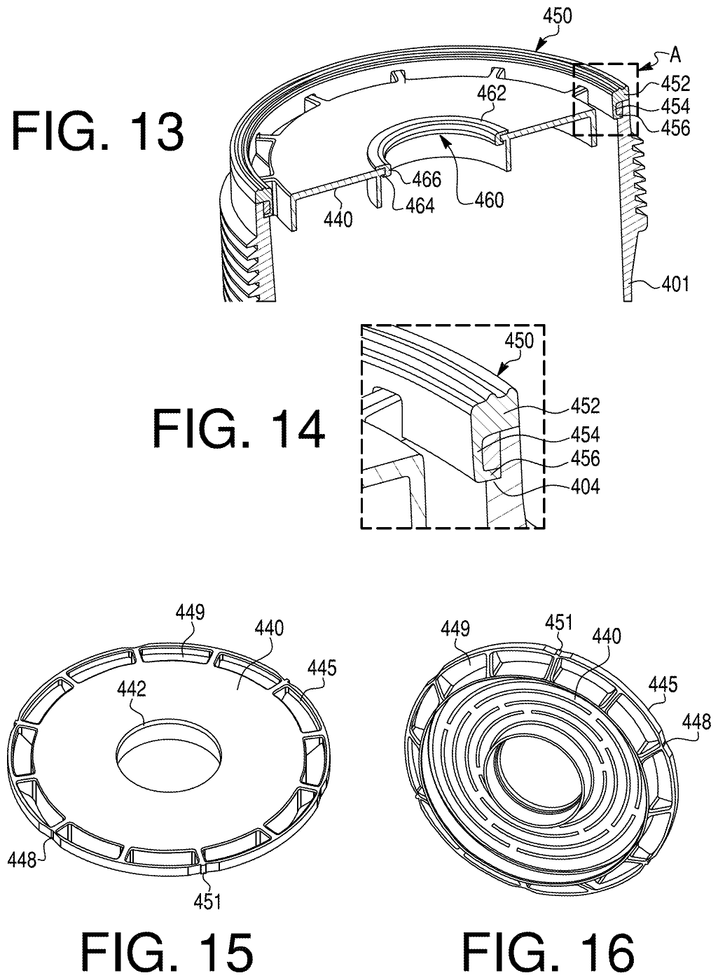

The second sealing member 460 is disposed around an inner periphery of a rim of the central opening 442. As shown in FIG. 13, the second sealing member 460 has a second sealing member first portion 462 disposed on an axially upper surface of the top end cap 440, a second sealing member second portion 464 disposed on an axially lower surface of the top end cap 440, and a second sealing member sealing portion 466 disposed radially inwards of the rim such that the second sealing member 460 defines a C-shaped cross-section. The second sealing member sealing portion 466 contacts an outer surface of the filter head outlet conduit 418 when the filter head outlet conduit 418 is inserted through the central opening 442 and forms a radial seal therewith. The C-shaped cross-section of the second sealing member 460 allows the second sealing member 460 to be coupled to the rim of the central opening 442 via a snap-fit.

In other embodiment, the top end cap 440 may include a filter element outlet conduit, for example, the filter element outlet conduit 142, 242, 342 extending axially away from the filter media 432 and insertable into the filter head outlet conduit 418. In such embodiments, the second sealing member may include the second sealing member 460 disposed on a radially outward surface of the filter element outlet conduit such that the second sealing member forms a seal between the radially outward surface of the filter element outlet conduit and a radially inward surface of the filter head outlet conduit 418 when the filter element outlet conduit is inserted into the filter head outlet conduit 418.

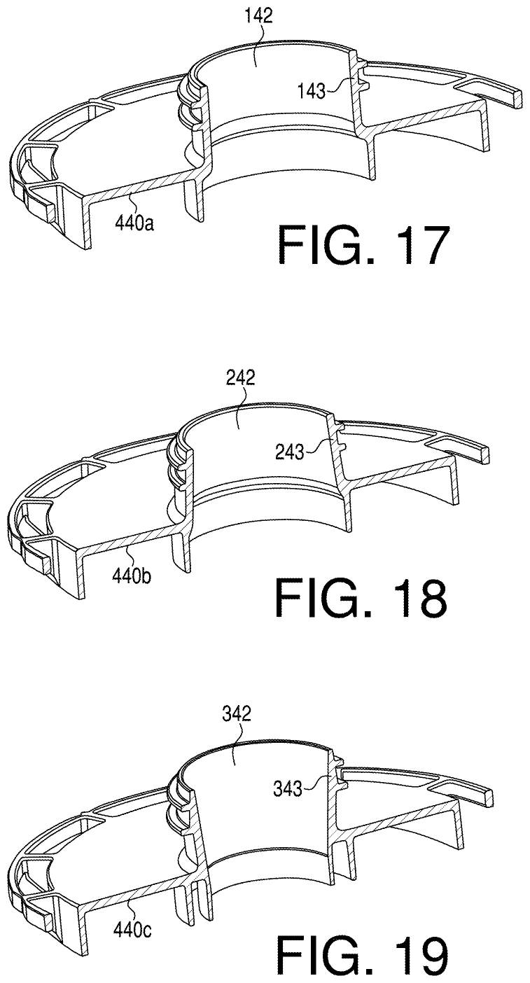

For example, FIG. 17 shows a top end cap 440a according to an embodiment. The top end cap 440a is substantially similar to the top end cap 440, but instead of the central opening 442, includes the filter element outlet conduit 142 that extends from an inner rim of the top end cap 440a and defines the groove 143, as previously described. FIG. 18 shows a top end cap 440b according to another embodiment. The top end cap 440b is substantially similar to the top end cap 440, but instead of the central opening 442, includes the conical filter element outlet conduit 242 that extends from an inner rim of the top end cap 440b and defines the groove 243, as previously described. Similarly, FIG. 19 shows a top end cap 440c according to still another embodiment. The top end cap 440c is substantially similar to the top end cap 440, but instead of the central opening 442, includes the divergent filter element outlet conduit 342 that extends from an inner rim of the top end cap 440c and defines the groove 343, as previously described.

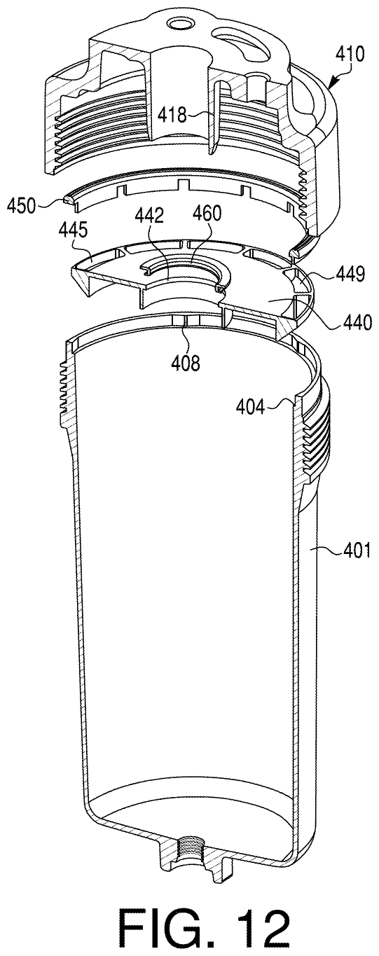

Referring to FIGS. 12-16, a plurality of openings 449 are defined through the top end cap 440 proximate to and radially inwards of an outer peripheral edge 445 of the top end cap 440. As shown in FIGS. 15-16, each of the plurality of openings 449 may include circumferential slots. Dirty fluid enters through the plurality of openings 449 around the filter media 432 and is filtered as it passes through the filter media 432 towards the central channel 472. The housing 401 defines a circumferential housing ledge 404 proximate to a top end of the housing 401 proximate to the filter head 410. An outer peripheral portion of the top end cap 440 is disposed over the housing ledge 404 such that the plurality of openings 449 are located radially inwards of the housing ledge 404.

A plurality of detents 408 are defined on an inner surface of the filter housing 401 between the housing ledge 404 and the top end of the filter housing 401. The plurality of detents 408 are configured to mate with a respective indent 448 of a plurality of indents 448 defined on an outer peripheral edge 445 of the top end cap 440. In some embodiments, a protrusion 451 may extend radially outwards from a base of a selected number of the plurality of indents 448 (e.g., every alternate indent 448). The protrusions 451 may serve to provide an interference fit between the top end cap 440 and a corresponding detent 408 of the plurality of detents 408.

The first sealing member 450 includes a first sealing member sealing portion 452 that is disposed on the axially upper surface of the top end cap 440 proximate to the radially outer peripheral edge 445 of the top end cap 440. The first sealing member sealing portion 452 may have a width such that a portion of the first sealing member sealing portion 452 extends over the top end of the filter housing 401 such that first sealing member sealing portion 452 forms an axial seal between the filter head 410, the top end cap 440 and the filter housing 401.

A set of first sealing member arms 454 extend axially downward from a radially inner edge of the first sealing member sealing portion 452 and are disposed through a respective one of the plurality of openings 449. First sealing member ledges 456 extends from an axially lower end of each of the first sealing member sealing portion 452 radially outwards such that the first sealing member 450 defines a C-shaped cross-section at locations where the first sealing member arms 454 are located. The first sealing member ledges 456 are disposed underneath the outer peripheral edge 445 of the top end cap 440 such that first sealing member arms 454 and first sealing member ledges 456 serve to snap-fit the first sealing member 450 onto the top end cap 440. Moreover, each of the first sealing member ledges 456 is interposed between the housing ledge 404 and the outer peripheral edge 445 of the top end cap 440, and is secured by the pressure exerted by the filter head 410 when the filter head 410 is coupled to the filter cartridge 400. This arrangement facilitates servicing of the filter cartridge 400 by facilitating removal of the first sealing member 450 during removal of the filter cartridge 400 from the filter head 410 even if a portion of the first sealing member that contacts the filter head 410 is stuck to the filter head 410.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A filter cartridge, comprising
a filter housing defining an internal volume;
a filter element disposed within the internal volume, the filter element comprising:
a filter media, and
an end cap coupled to a top end of the filter media, the top end positionable proximate to a filter head, a filter element outlet conduit extending from an inner rim of the end cap towards the filter head and extendable into a filter head outlet conduit of the filter head, and an end cap ledge extending radially outwards from an outer periphery of the end cap;
a first sealing member disposed around the outer periphery of the end cap at least partially on the end cap ledge; and
a second sealing member disposed around the filter element outlet conduit on on an outer periphery of the filter element outlet conduit,
wherein the first sealing member forms an axial seal between the end cap and the filter head, and the second sealing member forms a radial seal between the radially outward surface of the filter element outlet conduit and a radially inward surface of the filter head outlet conduit when the filter cartridge is coupled to the filter head.

2. The filter cartridge of claim 1, wherein:
the filter housing further comprises a first housing ledge defined on an inner surface of the filter housing proximate to the end cap ledge, at least a portion of the first sealing member disposed on the first housing ledge, and
the first sealing member also forms an axial seal between the filter head and the filter housing.

3. The filter cartridge of claim 2, wherein
a plurality of detents are formed on the inner surface of the housing below the first housing ledge, and
a plurality of indents are formed on an outer peripheral surface of the end cap ledge, the plurality of indents formed at locations corresponding to the plurality of detents such that each of the plurality of detents is inserted into a corresponding indent of the plurality of indents when the filter element is disposed in the filter housing.

4. The filter cartridge of claim 2, wherein the filter housing further comprises a second housing ledge extending radially inwards from the inner surface of the filter housing below the first housing ledge, at least a portion of the end cap ledge being disposed on the second housing ledge when the filter element is disposed in the filter housing.

5. The filter cartridge of claim 1, wherein the filter element outlet conduit comprises a cylindrical wall having a substantially uniform cross-section.

6. The filter cartridge of claim 1, wherein the filter element outlet conduit comprises a conical wall inclined radially inwards from an upstream end to a downstream end of the filter element outlet conduit such that the upstream end of the filter element outlet conduit has a larger cross-section than the downstream end.

7. The filter cartridge of claim 1, wherein the filter element outlet conduit comprises a conical wall inclined radially outwards from an upstream end to a downstream end of the filter element outlet conduit such that the downstream end of the filter element outlet conduit has a larger cross-section than the upstream end.

8. The filter cartridge of claim 1, wherein the first sealing member has a rectangular cross-section.

9. The filter cartridge of claim 1, wherein the end cap further comprises a plurality of protrusions formed on the outer periphery of the end cap axially upwards of the end cap ledge, the plurality of protrusions structured to secure the first sealing member to the outer periphery.

10. The filter cartridge of claim 1, wherein the end cap further comprises a plurality of openings defined proximate to and radially inwards of the outer periphery of the top end cap.

11. A filter cartridge, comprising
a filter housing defining an internal volume;
a filter element disposed within the internal volume, the filter element comprising:
a filter media, and
an end cap coupled to a top end of the filter media, the top end positionable proximate to a filter head, the end cap defining a central opening around a longitudinal axis of the filter cartridge, the central opening structured to receive a filter head outlet conduit of the filter head, and a plurality of openings defined proximate to and radially inwards of an outer peripheral edge of the top end cap;
a first sealing member disposed proximate to an outer periphery of the end cap and coupled to the end cap, at least a portion of the first sealing member at least partially extending through at least one of the plurality of openings; and
a second sealing member disposed around an inner periphery the central opening,
wherein the first sealing member forms an axial seal between the end cap and the filter head, and the second sealing member forms a radial seal between the inner periphery of the central opening and the filter head outlet conduit of the filter head when the filter cartridge is coupled to the filter head.

12. The filter cartridge of claim 11, wherein at least a portion of the first sealing member defines a C-shaped cross-section.

13. The filter cartridge of claim 12, wherein:
the first sealing member comprises:
a first sealing member sealing portion disposed on axially upper surface of the end cap,
a set of first sealing member arms extending axially downward from a radially inner edge of the first sealing member sealing portion and disposed through a respective one of the plurality of openings, and
first sealing member ledges extending radially outward from an axially lower end of each of the first sealing member sealing portion, the first sealing member ledges being disposed underneath the outer peripheral edge.

14. The filter cartridge of claim 11, wherein the second sealing member comprises:
a second sealing member first portion disposed on an axially upper surface of the top end cap;
a second sealing member second portion disposed on an axially lower surface of the top end cap; and
a second sealing member sealing portion disposed radially inwards of the inner periphery of the central opening.

15. A filter cartridge, comprising
a filter housing defining an internal volume;
a filter element disposed within the internal volume, the filter element comprising:
a filter media comprising a first end and a second end opposite the first end, and
an end cap coupled to the first end of the filter media, a filter element outlet conduit extending from an inner rim of the end cap away from the second end;
a first sealing member disposed proximate to a radially outer periphery of the end cap and coupled to the end cap, the first sealing member comprising:
a first sealing member sealing portion disposed on a surface of the end cap that is axially opposite the filter media, and
a set of first sealing member arms extending axially toward the second end from a radially inner edge of the first sealing member sealing portion and disposed radially inwards of an outer peripheral edge of the end cap; and
a second sealing member disposed around the filter element outlet conduit on a radially outward surface of the filter element outlet conduit.

16. The filter cartridge of claim 15, wherein:
the end cap further comprises a plurality of openings defined proximate to and radially inwards of the outer peripheral edge of the end cap;
each of the set of first sealing member arms is disposed through a respective one of the plurality of openings; and
the first sealing member further comprises first sealing member ledges extending radially outward from an axially lower end of each of the first sealing member arms, the first sealing member ledges being disposed underneath the outer peripheral edge.

17. The filter cartridge of claim 16, wherein a portion of the first sealing member sealing portion extends axially outwards of the outer peripheral edge of the end cap and is disposed on an axial upper end of the filter housing to also form an axial seal therewith.

18. The filter cartridge of claim 15, wherein the filter element outlet conduit comprises a cylindrical wall having a substantially uniform cross-section.

19. The filter cartridge of claim 15, wherein the filter element outlet conduit comprises a conical wall inclined radially inwards from an upstream end to a downstream end of the filter element outlet conduit such that the upstream end of the filter element outlet conduit has a larger cross-section than the downstream end.

20. The filter cartridge of claim 19, wherein the filter element outlet conduit comprises a conical wall inclined radially outwards from an upstream end to a downstream end of the filter element outlet conduit such that the downstream end of the filter element outlet conduit has a larger cross-section than the upstream end.
